(19) United States
(12) Patent Application Publication
(10) Pub. No.: US 2013/0038598 A1
(43) Pub. Date: Feb. 14, 2013

(54) Image Processor, Display System, and Method for Producing Three Dimension Images

(71) Applicant: Cheng-Che Tsai, Tainan City (TW)

(72) Inventor: Cheng-Che Tsai, Tainan City (TW)

(73) Assignee: HIMAX TECHNOLOGIES LIMITED, Tainan City (TW)

(21) Appl. No.: 13/204,815

(22) Filed: Aug. 8, 2011

(51) Int. Cl. G06T 15/00

(52) U.S. Cl. 345/419

(57) ABSTRACT

An image processor which produces three dimension images according to a shift signal includes a receive circuit, a pixel select circuit, a pixel arrange circuit, and a shift circuit, in which the receive circuit receives the left eye pictures and the right eye pictures, the pixel select circuit selects pixel information from the left eye pictures and the right eye pictures, the pixel arrange circuit arranges the selected pixel information onto a lot of positions for right eye or left eye of the viewer, and the shift circuit shifts the arranged pixel information when the shift signal is asserted.

### BACKGROUND

1. Field of Invention

The present invention relates to a three dimension display. More particularly, the present invention relates to a three dimension display related to a naked eye solution.

2. Description of Related Art

To meet the requirements for reproducing natural images, display technology has gradually changed from the two-dimensional displays to the three-dimensional displays. As early as Euclid and Aristotle's age, people noted that although there are two eyes receiving different images, people are prevented from suffering double image problems. After a lot of animal and human tests, the human brain's ability to reproduce the image's depth has been proved.

The three-dimensional vision is formed because of the binocular parallax phenomenon, which is caused as a result of receiving images from different angles by the left eye and the right eye. The images of different angles are merged to reproduce three-dimensional images by the human brain. The three-dimensional image displaying technique includes the glasses wearing type and the naked eye type. The glasses wearing type makes the user un-comfortable, therefore is not popular. On the other hand, the naked eye type has become more and more popular.

FIG. 1 shows a diagram depicting how the three dimension images are perceived. In order to form three-dimensional vision, the two dimension image 101 is divided into the right eye pictures 101b and the left eye pictures 101a which are projected to the right eye 109 and the left eye 107 of the viewer simultaneously with a parallax barrier 105 or a micro-lens array (not shown).

However, the viewer needs to stand on the certain positions to get the correct three dimension images in this naked eye method. If the viewer stands on the wrong position, the three dimension images can not be perceived correctly.

Hence, there is a need for a new three dimension display technology which can present the correct three-dimension images to the viewer.

### SUMMARY

According to one embodiment of the present invention, an image processor for producing three dimension images according to a shift signal responding a position state of a viewer is disclosed, in which the image processor includes a receive circuit, a pixel select circuit, a pixel arrange circuit, and a shift circuit. The receive circuit receives a plurality of left eye pictures and a plurality of right eye pictures; the pixel select circuit, electrically connected to the receive circuit, selects pixel information from the left eye pictures and the right eye pictures; the pixel arrange circuit, electrically connected to the pixel select circuit, arranges the selected pixel information onto a plurality of positions for the right eye or the left eye of a viewer; and the shift circuit, electrically connected to the pixel arrange circuit, shifts the arranged pixel information when the shift signal is asserted.

According to another embodiment of the present invention, a display system for displaying the three dimension images is disclosed, in which the display system includes an image sensor, a receive circuit, a pixel select circuit, a pixel arrange circuit, and a shift circuit. The receive circuit receives a plurality of left eye pictures and a plurality of right eye pictures; the pixel select circuit, electrically connected to the receive circuit, selects the pixel information from the left eye pictures and the right eye pictures; the pixel arrange circuit, electrically connected to the pixel select circuit, arranges the selected pixel information onto a plurality of positions for the right eye or the left eye of a viewer; the image sensor senses a position state of the viewer and asserts a shift signal when the sensed position state is out of range; and the shift circuit, electrically connected to the pixel arrange circuit and the image sensor, shifts the arranged pixel information when the shift signal is asserted.

According to still another embodiment of the present invention, a method for producing three dimension images according to a position state of a viewer is disclosed. The method receives a plurality of left eye pictures and a plurality of right eye pictures derived from a two dimension image and selects pixel information from the left eye pictures and the right eye pictures. The method also arranges the selected pixel information onto a plurality of positions for a right eye or a left eye of the viewer and shifts the arranged pixel information according to the position state of the viewer.

According to the other embodiment of the present invention, a method for producing three dimension images according a position state of a viewer is disclosed. The method receives a plurality of left eye pictures and a plurality of right eye pictures from a two dimension image and selects pixel information from the left eye pictures and the right eye pictures. Next, the method arranges the selected pixel information onto a plurality of positions for a right eye or a left eye of the viewer, senses a position state of the viewer, and shifts the arranged pixel information when the sensed position state is out of range. It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows a diagram depicting how the three dimension images are perceived;

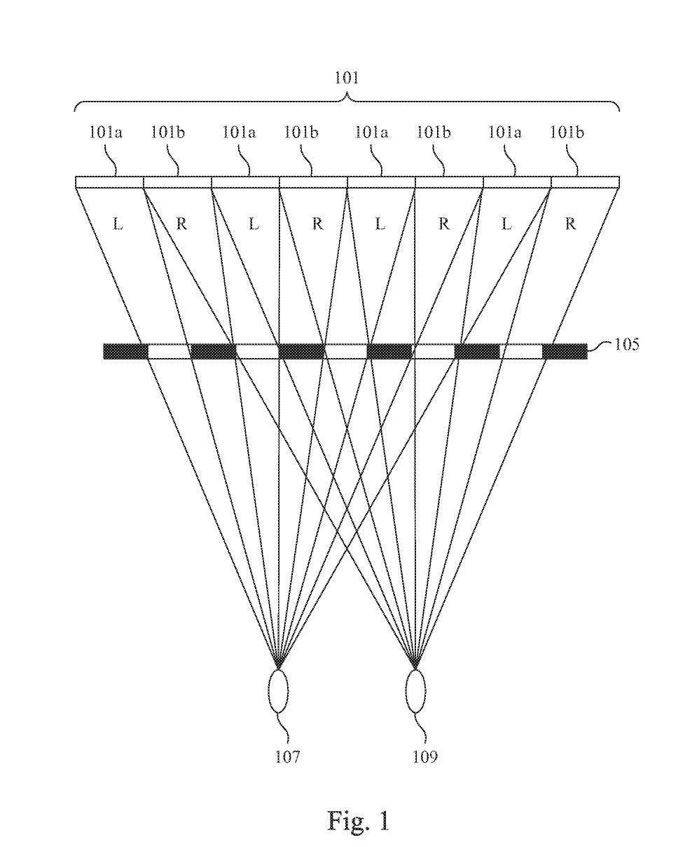

FIG. 2 shows the block diagram of the display system according to one embodiment of the present invention;

FIG. 3A, FIG. 3B, and FIG. 3C show the diagram of the 2 views three dimension images according to one embodiment of the present invention;

FIG. 4A, FIG. 4B, and FIG. 4C show the diagram of the 5 views three dimension images according to another embodiment of the present invention.

FIG. 5 shows a flowchart of a method for producing three dimension images according to one embodiment of the present invention; and

FIG. 6 shows a flowchart of a method for producing three dimension images according to one embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The display system of the following embodiments adopt the naked eye technique to generate the three dimension images of multi-views, and the viewer can perceive correct three dimension image even standing on different positions.

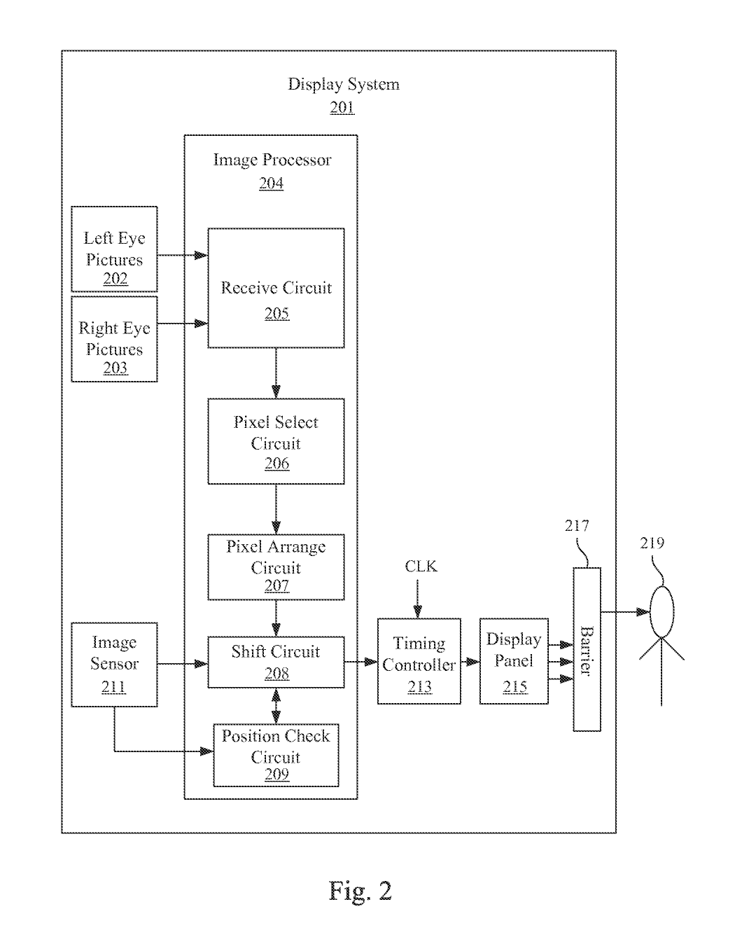

FIG. 2 shows the block diagram of the display system according to one embodiment of the present invention. The display system 201 displays the three dimension images, in which the display system 201 substantially includes an image sensor 211 and an image processor 204 that contains a receive circuit 205, a pixel select circuit 206, a pixel arrange circuit 207, a shift circuit 208, and a position check circuit 209.

The receive circuit 205 receives a lot of left eye pictures 202 and a lot of right eye pictures 203. The pixel select circuit 206, electrically connected to the receive circuit 205, selects the pixel information from the left eye pictures 202 and the right eye pictures 203. The pixel information selected from the left eye pictures 202 and the right eye pictures 203 can be the information for the pixels which include a lot of red sub-pixels, a lot of green sub-pixels, and a lot of blue sub-pixels; the pixel information selected from the left eye pictures 202 and the right eye pictures 203 can also be the information for the sub-pixels.

The pixel arrange circuit 207, electrically connected to the pixel select circuit 206, arranges the selected pixel information onto the positions for the right eye or the left eye of a viewer 219. For example, the pixel select circuit 206 can choose one part from every left eye pictures 202 and every right eye pictures 203 as the selected pixel information; then the pixel arrange circuit 207 combines these chosen parts and puts these chosen parts onto the positions for the right eye or the left eye of a viewer 219 to be three dimensionally perceived.

The image sensor 211 senses the position state of a viewer 219, and the shift signal is asserted by the image sensor 211 when the sensed position state of the viewer 219 is out of range. For example, the image sensor 211 can detect the height, the angle, the direction of the viewer 219; if the detected height, the detected angle, or the detected direction of the viewer 219 is out of range, the image sensor 211 will assert the shift signal to make the shift circuit 208 shift the arranged pixel information.

After the chosen parts are combined into the new image by the pixel arrange circuit 207, the shift circuit 208, electrically connected to the pixel arrange circuit 207 and the image sensor 211, maintains the arrangement of pixel information as the same when the shift signal is not asserted; otherwise, the shift circuit 208 will shift the arranged pixel information when the shift signal is asserted. After that, the position check circuit 209 checks whether the shifted pixel information is correctly corresponding to the left eye or the right eye of the viewer 219. If the shifted pixel information is not correctly corresponding to the left eye and the right eye, the position check circuit 209 can make the shift circuit 208 shift the pixel information again.

For example, the shift circuit 208 can shift the pixel information once to make them move into the next positions if the display system is the 2 view type. The position check circuit 209 can also make the shift circuit 208 continue to shift the pixel information when the shifted pixel information can not be correctly projected to the left eye or the right eye of the viewer 219 through the barrier 217. In fact, the position check circuit 209 can make the shift circuit 208 shift the pixel information 5 times at the most if the display system is 5 view type.

The display system 201 can further include a timing controller 213, a display panel 215, and a barrier 217. The timing controller 213 sequentially outputs the pixel information from the image processor 204 to the display panel 215 according a clock signal CLK, then the display panel 215 including a lot of pixel circuits displays the pixel information outputted from the timing controller 213. The barrier 217 is disposed corresponding to the display panel 215 for blocking the project direction of the pixel information, such that the pixel information can be separately projected to the right eye and the left eye of the viewer 219.

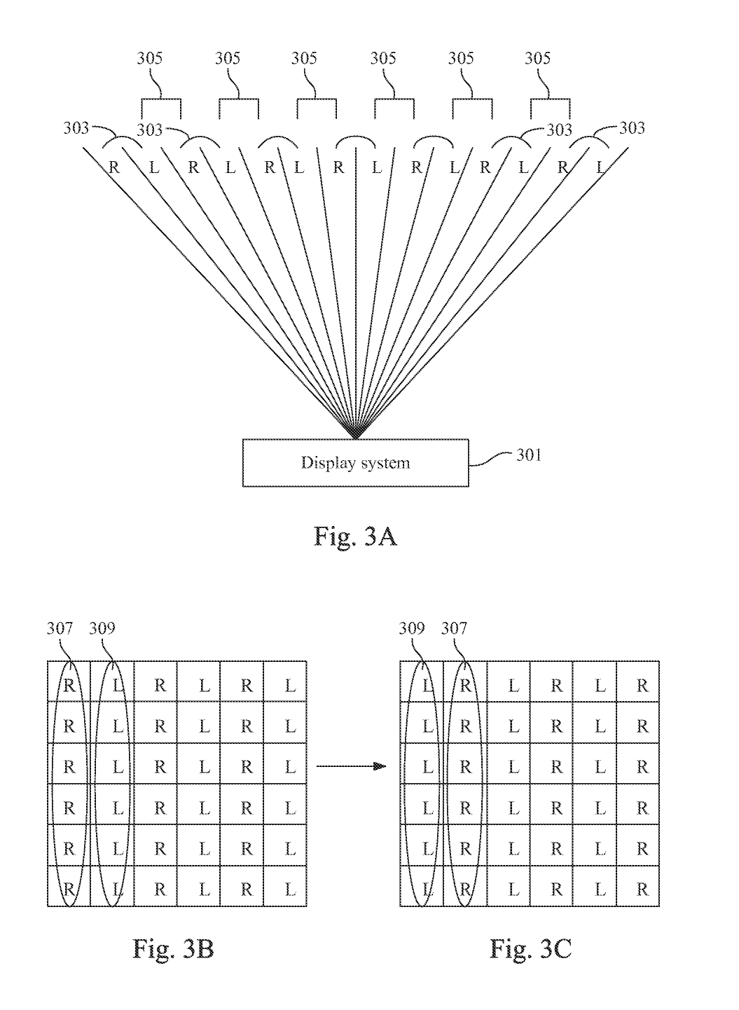

FIG. 3A, FIG. 3B, and FIG. 3C show the diagram of the 2 view three dimension images according to one embodiment of the present invention. As shown in FIG. 3A, the display system 301 projects the images to the viewer standing on the positions 303 or the positions 305. The display system 301 first projects the pixel information arranged as FIG. 3B where the right eye sub-pixel columns 307 are first positioned. With the pixel information arranged as FIG. 3B, the viewers standing on the positions 303 can perceive the correct three dimension images while the viewers standing on the positions 305 can not perceive the correct three dimension images.

Therefore, if most of the viewers are standing on the positions 305, then the display system 301 needs to shift the pixel information to make the left eye sub-pixel column 309 positioned ahead of the right eye sub-pixel column 307 as shown in FIG. 3C, and the viewer standing in the positions 305 can perceive the correct three dimension images.

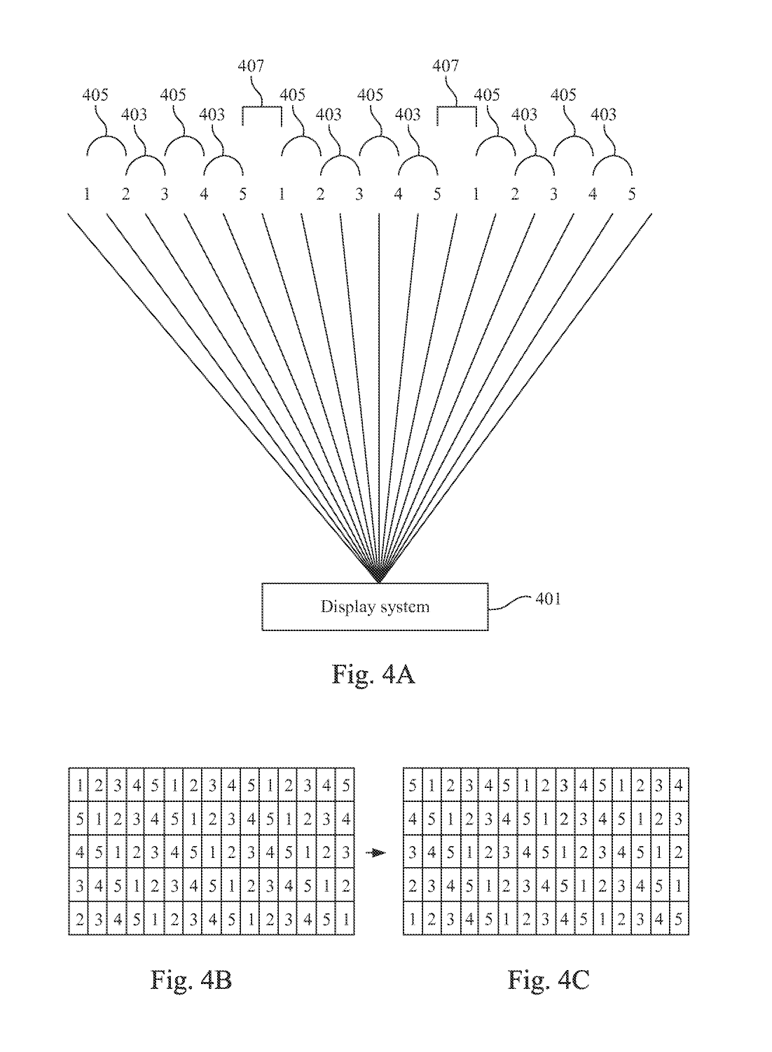

FIG. 4A, FIG. 4B, and FIG. 4C show the diagram of the 5 view three dimension images according to another embodiment of the present invention. The display system 401 projects the images to the viewer standing on the positions 403, the positions 405, and the position 407. The display system 401 first projects the pixel information arranged as FIG. 4B where the pixel information in one row are in the sequence of 1, 2, 3, 4, 5. With the pixel information arranged as FIG. 4B, the viewers standing on the positions 403 and the positions 405 can perceive the correct three dimension images while the viewers standing on the positions 407 can not perceive the right three dimension images.

Therefore, if most of the viewers are standing on the positions 407, then the display system 401 needs to shift the pixel information to make the pixel information of one row is in the sequence of 5, 1, 2, 3, 4, as shown in FIG. 4C, and the viewer standing in the positions 407 can perceive the correct three dimension images.

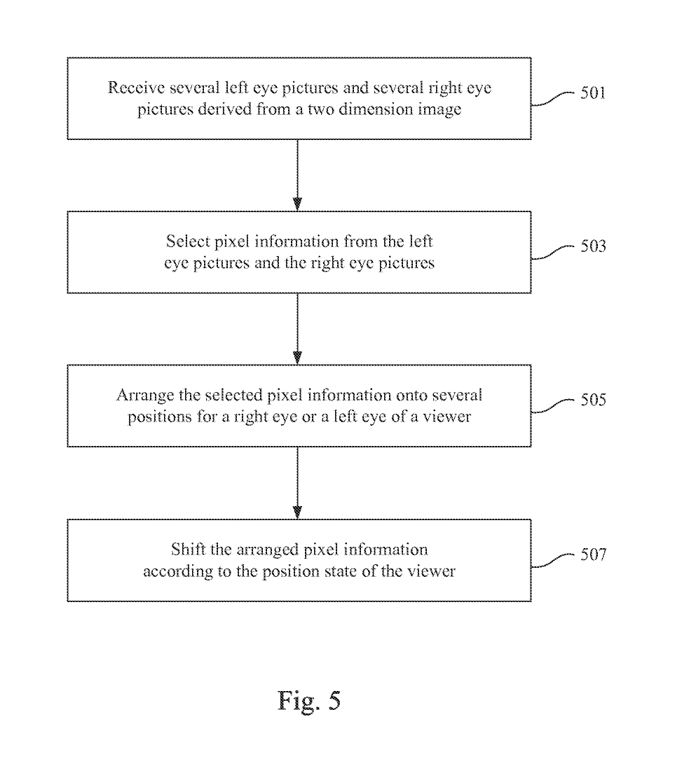

FIG. 5 shows a flowchart of a method for producing three dimension images according to one embodiment of the present invention. As shown in FIG. 5, the method first receives several left eye pictures and several right eye pictures derived from a two dimension image (step 501) and selects pixel information from the left eye pictures and the right eye pictures (step 503). After that, the method arranges the selected pixel information onto several positions for a right eye or a left eye of a viewer (step 505) and shifts the arranged pixel information according to the position state of the viewer (step 507).

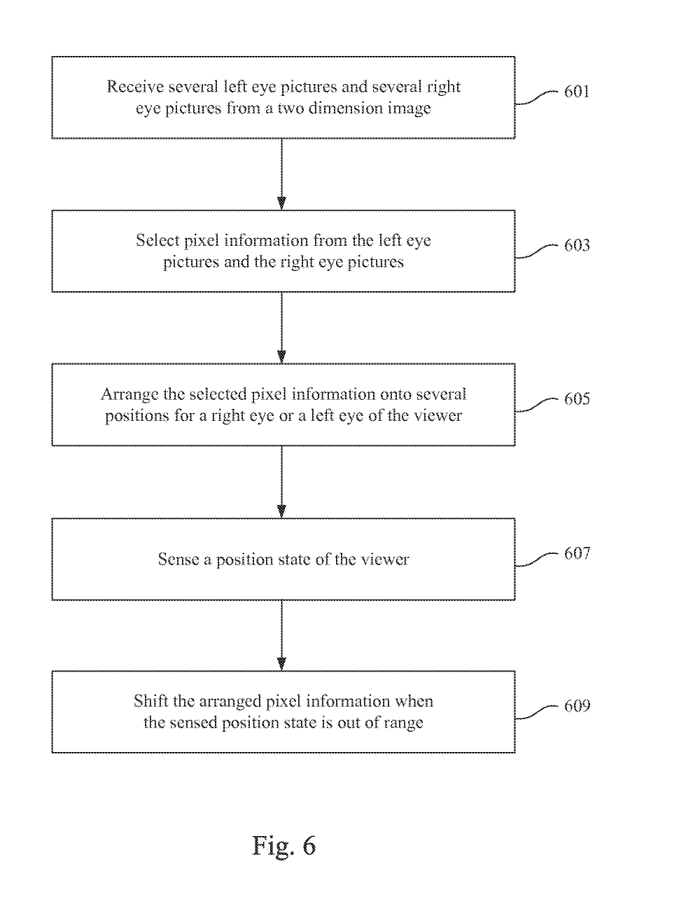

FIG. 6 shows a flowchart of a method for producing three dimension images according to one embodiment of the present invention. As shown in FIG. 6, the method first receives several left eye pictures and several right eye pictures from a two dimension image (step 601) and selects pixel information from the left eye pictures and the right eye pictures (step 603). Next, the method arranges the selected pixel information onto several positions for right eye or left eye of the viewer (step 605), senses a position state of the viewer (step 607), and shifts the arranged pixel information when the sensed position state is out of range (step 609).

According to the above embodiments, the display system and the method thereof can detect the position of the viewer and can rearrange the pixel information automatically if the position of the viewers is out of range, such that the pixel information can be correctly projected to the right eye and the left eye of the viewer. Therefore, the viewer can still perceive the correct three dimension images even if the position of the viewer is moved or different.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image processor for producing three dimension images according to a shift signal responding a position state of a viewer, the image processor comprising:
a receive circuit for receiving a plurality of left eye pictures and a plurality of right eye pictures;
a pixel select circuit, electrically connected to the receive circuit, for selecting pixel information from the left eye pictures and the right eye pictures;
a pixel arrange circuit, electrically connected to the pixel select circuit, for arranging the selected pixel information onto a plurality of positions for right eye or left eye of the viewer; and
a shift circuit, electrically connected to the pixel arrange circuit, for shifting the arranged pixel information when the shift signal is asserted.

2. The image processor for producing the three dimension images as claimed in claim 1, further comprising a position check circuit for checking if the shifted pixel information is corresponding to the left eye or the right eye correctly.

3. The image processor for producing the three dimension images as claimed in claim 2, wherein the shift circuit continues to shift the pixel information that had been shifted when the shifted pixel information are not projected to the left eye or the right eye correctly.

4. The image processor for producing the three dimension images as claimed in claim 1, wherein the pixel information selected from the left eye pictures and the right eye pictures is the information for pixels which include a plurality of red sub-pixels, a plurality of green sub-pixels, and a plurality of blue sub-pixels.

5. The image processor for producing the three dimension images as claimed in claim 1, wherein the pixel information selected from the left eye pictures and the right eye pictures is the information for sub-pixels.

6. A display system for displaying three dimension images, the display system comprising:
a receive circuit for receiving a plurality of left eye pictures and a plurality of right eye pictures;
a pixel select circuit, electrically connected to the receive circuit, for selecting pixel information from the left eye pictures and the right eye pictures;
a pixel arrange circuit, electrically connected to the pixel select circuit, for arranging the selected pixel information onto a plurality of positions for right eye or left eye of a viewer;
an image sensor for sensing a position state of the viewer and for asserting a shift signal when the sensed position state is out of range; and
a shift circuit, electrically connected to the pixel arrange circuit and the image sensor, for shifting the arranged pixel information when the shift signal is asserted.

7. The display system for displaying the three dimension images as claimed in claim 6, wherein the image sensor asserts the shift signal when the viewer's position is out of range.

8. The display system for displaying the three dimension images as claimed in claim 6, further comprising a display panel comprising a plurality of pixel circuits for displaying the pixel information.

9. The display system for displaying the three dimension images as claimed in claim 8, further comprising a barrier disposed corresponding to the display panel for blocking the projecting direction of the pixel information.

10. The display system for displaying the three dimension images as claimed in claim 6, further comprising a position check circuit for checking whether the shifted pixel information is corresponding to the left eye or the right eye of the viewer correctly.

11. The display system for displaying the three dimension images as claimed in claim 10, wherein the shift circuit continues to shift the pixel information when the shifted pixel information is not corresponding to the left eye or the right eye of the viewer correctly.

12. The display system for displaying the three dimension images as claimed in claim 6, wherein the pixel information selected from the left eye pictures and the right eye pictures is the information for pixels which include a plurality of red sub-pixels, a plurality of green sub-pixels, and a plurality of blue sub-pixels.

13. The display system for displaying the three dimension images as claimed in claim 6, wherein the pixel information selected from the left eye pictures and the right eye pictures is the information for sub-pixels.

14. A method for producing three dimension images according to a position state of a viewer, comprising:
receiving a plurality of left eye pictures and a plurality of right eye pictures derived from a two dimension image;
selecting pixel information from the left eye pictures and the right eye pictures;
arranging the selected pixel information onto a plurality of positions for a right eye or a left eye of the viewer; and
shifting the arranged pixel information according to the position state of a viewer.

15. The method for producing the three dimension images as claimed in claim 14, further comprising checking if the shifted pixel information is correctly corresponding to the left eye or the right eye.

16. The method for producing the three dimension images as claimed in claim 15, further comprising continuing to shift the pixel information that had already been shifted when the shifted pixel information is not projected to the left eye or the right eye correctly.

17. The method for producing the three dimension images as claimed in claim 14, wherein the pixel information selected from the left eye pictures and the right eye pictures is the information for pixels which include a plurality of red sub-pixels, a plurality of green sub-pixels, and a plurality of blue sub-pixels.

18. The method for producing the three dimension images as claimed in claim 14, wherein the pixel information selected from the left eye pictures and the right eye pictures is the information for sub-pixels.

19. A method for producing three dimension images according a position state of a viewer, comprising:
receiving a plurality of left eye pictures and a plurality of right eye pictures from a two dimension image;
selecting pixel information from the left eye pictures and the right eye pictures;
arranging the selected pixel information onto a plurality of positions for a right eye or a left eye of the viewer;
sensing the position state of the viewer; and
shifting the arranged pixel information when the sensed position state is out of range.

20. The method for producing the three dimension images as claimed in claim 19, further comprising asserting a shift signal when the viewer's position is out of range.
